(19) United States
(12) Patent Application Publication
(10) Pub. No.: US 2009/0165275 A1
(43) Pub. Date: Jul. 2, 2009

(54) METHOD FOR REPAIRING A COOLED TURBINE NOZZLE SEGMENT

(76) Inventors: Michael Scott Cole, Mason, OH (US); James Herbert Deines, Mason, OH (US); Ching-Pang Lee, Cincinnati, OH (US)

Correspondence Address: GENERAL ELECTRIC COMPANY, GE AVIATION, ONE NEUMANN WAY MD H17, CINCINNATI, OH, 45215, US

(21) Appl. No.: 11/967,193

(22) Filed: Dec. 29, 2007

(51) Int. Cl. B23P 6/00

(52) U.S. Cl. 29/402.02

(57) ABSTRACT

A method for repairing a turbine nozzle segment having a band and a plurality of airfoils, where the band has a flange is described. The method includes the steps of repairing a damaged area on the turbine nozzle segment and drilling a plurality of cooling holes in the flange.

### BACKGROUND OF THE INVENTION

The exemplary embodiments relate generally to gas turbine engine components and more particularly to a method for repairing cooled turbine nozzle segments.

Gas turbine engines typically include a compressor, a combustor, and at least one turbine. The compressor may compress air, which may be mixed with fuel and channeled to the combustor. The mixture may then be ignited for generating hot combustion gases, and the combustion gases may be channeled to the turbine. The turbine may extract energy from the combustion gases for powering the compressor, as well as producing useful work to propel an aircraft in flight or to power a load, such as an electrical generator.

The turbine may include a stator assembly and a rotor assembly. The stator assembly may include a stationary nozzle assembly having a plurality of circumferentially spaced apart airfoils extending radially between inner and outer bands, which define a flow path for channeling combustion gases therethrough. Typically the airfoils and bands are formed into a plurality of segments, which may include one or two spaced apart airfoils radially extending between an inner and an outer band. The segments are joined together to form the nozzle assembly. The band may include one or more flanges for attaching the nozzle assembly to other components of the gas turbine engine.

The rotor assembly may be downstream of the stator assembly and may include a plurality of blades extending radially outward from a disk. Each rotor blade may include an airfoil, which may extend between a platform and a tip. Each rotor blade may also include a root that may extend below the platform and be received in a corresponding slot in the disk. Alternatively, the disk may be a blisk or bladed disk, which may alleviate the need for a root and the airfoil may extend directly from the disk. The rotor assembly may be bounded radially at the tip by a stationary annular shroud. The shrouds and platforms (or disk, in the case of a blisk) define a flow path for channeling the combustion gases therethrough.

As gas temperatures rise due to the demand for increased performance, components may not be able to withstand the increased temperatures. Higher gas temperatures lead to higher metal temperatures, which is a primary contributor to distress. Distress may cause cracking or holes to form within these areas, leading to decreased performance and higher repair costs. Higher pressure and temperature areas suffer the greatest distress. As shown in FIG. 1, one such higher temperature and pressure area 80 is between the trailing edges of the airfoils in a nozzle segment. In this area, the pressure and temperature combination is highest and is the most susceptible to damage.

### BRIEF DESCRIPTION OF THE INVENTION

In one exemplary embodiment, a method for repairing a turbine nozzle segment having a band and a plurality of airfoils, where the band has a flange, includes the steps of repairing a damaged area on the turbine nozzle segment and drilling a plurality of cooling holes in the flange.

In another exemplary embodiment, a method for repairing a turbine nozzle assembly having a band and a plurality of airfoils, the band having a flange having a plurality of cooling holes includes the steps of repairing a damaged area on the turbine nozzle segment and filling in the cooling holes. The method also includes drilling a plurality of new cooling holes in the flange.

### BRIEF DESCRIPTION OF THE DRAWINGS

FIG. 1 is a schematic diagram illustrating the pressures and temperatures of a typical turbine nozzle segment.

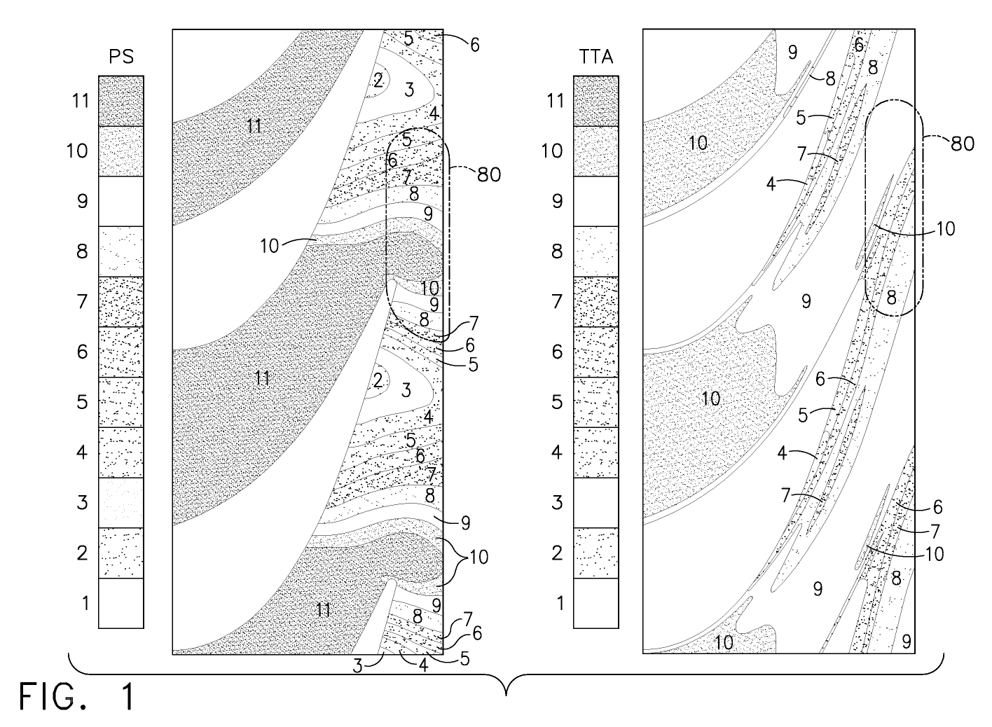

FIG. 2 is a cross-sectional view of an exemplary gas turbine engine.

FIG. 3 is a cross-sectional view of an exemplary embodiment of a turbine nozzle assembly.

FIG. 4 is a close-up cross-sectional view of the outer band area of an exemplary embodiment of a turbine nozzle assembly.

FIG. 5 is a perspective view of an exemplary embodiment of a turbine nozzle segment.

FIG. 6 is a top plan view of an exemplary embodiment of a turbine nozzle segment.

FIG. 7 is a perspective view of an exemplary embodiment of a turbine nozzle segment.

FIG. 8 is a cross-sectional view taken along line 8-8 in FIG. 3 of an exemplary embodiment of a turbine nozzle segment.

FIG. 9 is a close-up cross-sectional view of the aft end flowpath side of the outer band of an exemplary embodiment of a turbine nozzle segment before repair.

FIG. 10 is a close-up cross-sectional view of the aft end flowpath side of the outer band of an exemplary embodiment of a turbine nozzle segment after repair.

FIG. 11 is a cross-sectional view taken along line 8-8 in FIG. 3 of an exemplary embodiment of a turbine nozzle segment after repair.

FIG. 12 is a flow chart diagram of one exemplary embodiment of a method for repairing a turbine nozzle segment.

### DETAILED DESCRIPTION OF THE INVENTION

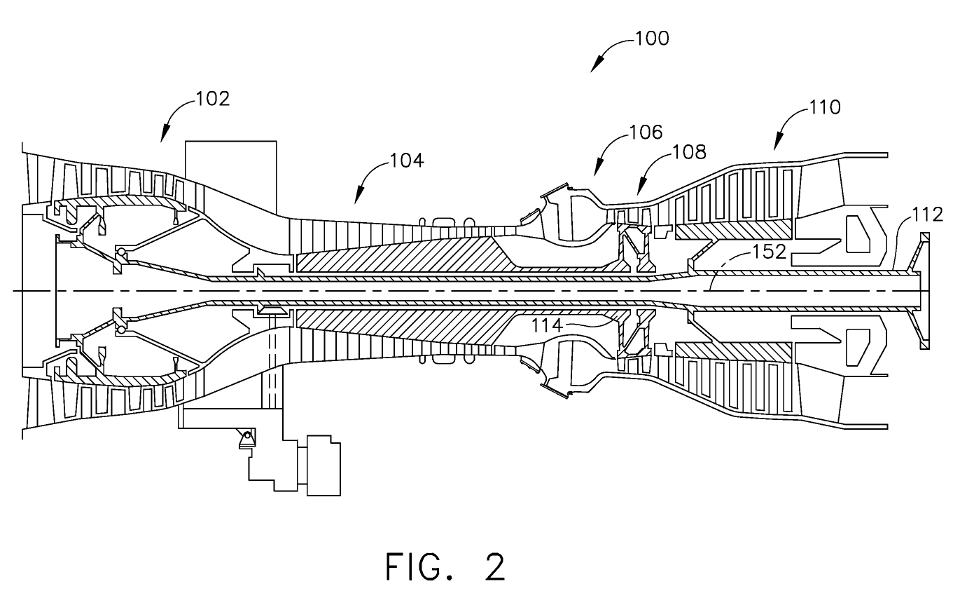

FIG. 2 illustrates a cross-sectional schematic view of an exemplary gas turbine engine 100. The gas turbine engine 100 may include a low-pressure compressor 102, a high-pressure compressor 104, a combustor 106, a high-pressure turbine 108, and a low-pressure turbine 110. The low-pressure compressor may be coupled to the low-pressure turbine through a shaft 112. The high-pressure compressor 104 may be coupled to the high-pressure turbine 108 through a shaft 114. In operation, air flows through the low-pressure compressor 102 and high-pressure compressor 104. The highly compressed air is delivered to the combustor 106, where it is mixed with a fuel and ignited to generate combustion gases. The combustion gases are channeled from the combustor 106 to drive the turbines 108 and 1 10. The turbine 110 drives the low-pressure compressor 102 by way of shaft 112. The turbine 108 drives the high-pressure compressor 104 by way of shaft 114.

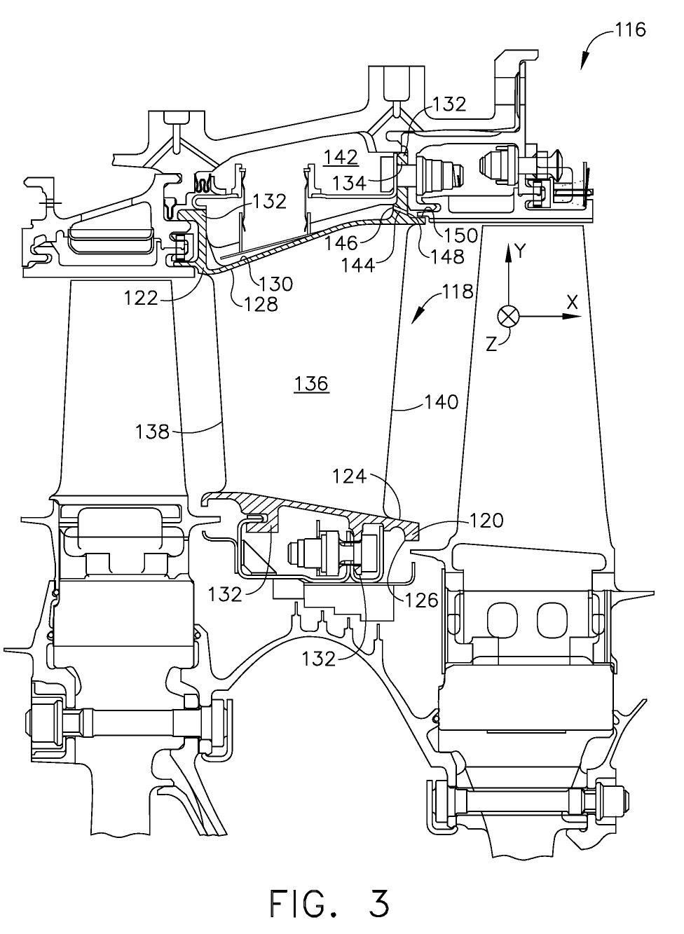

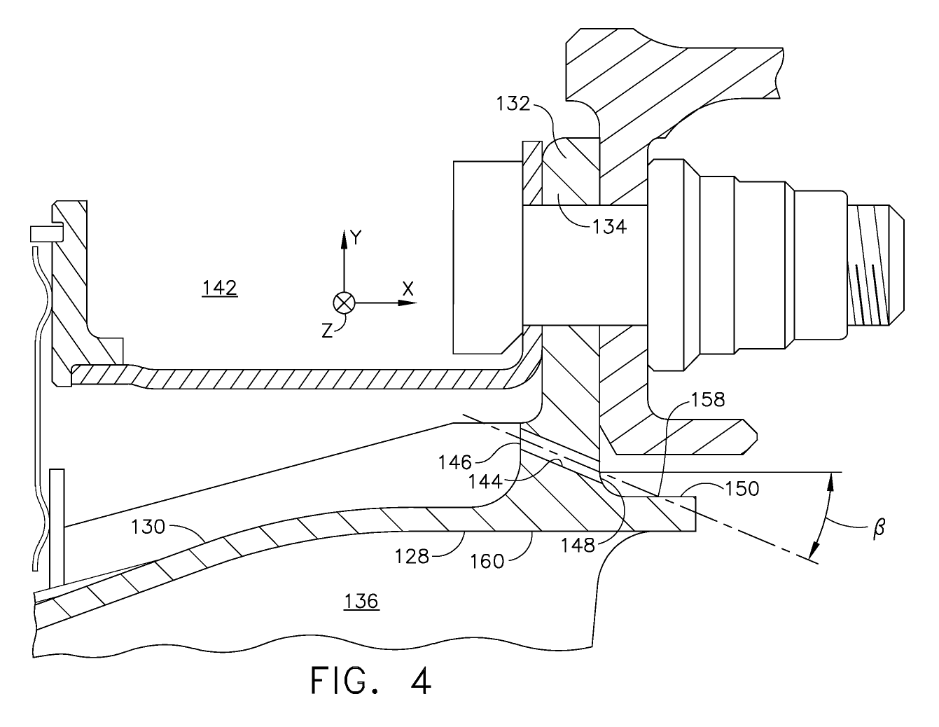

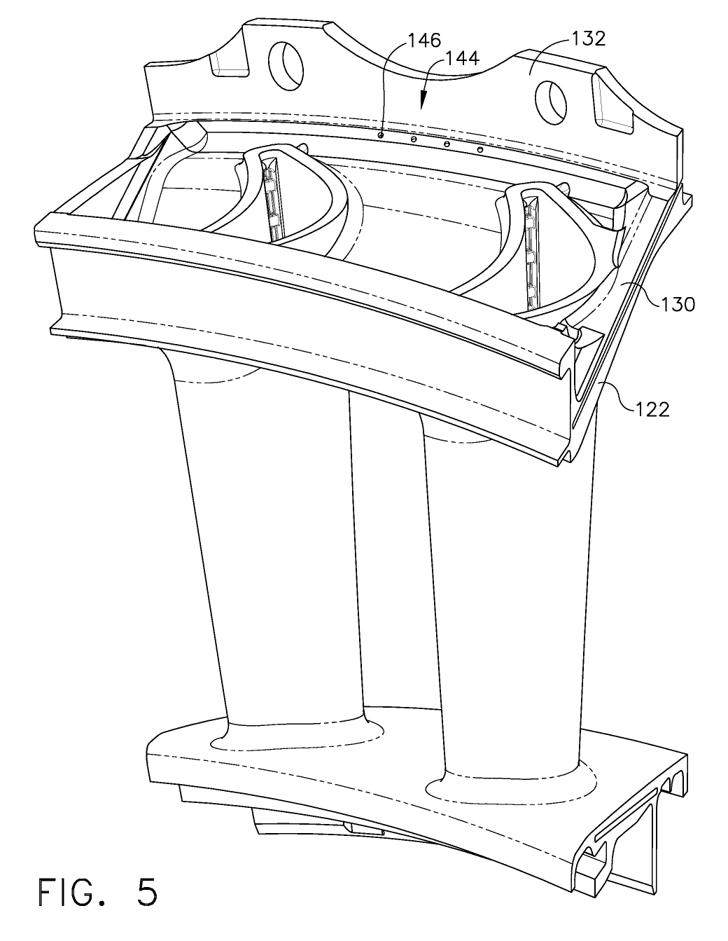

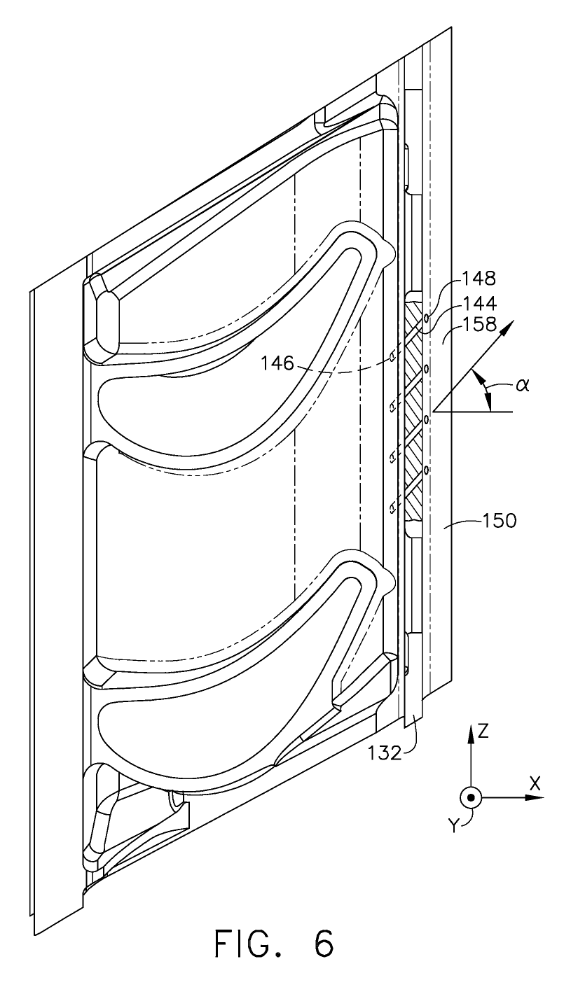

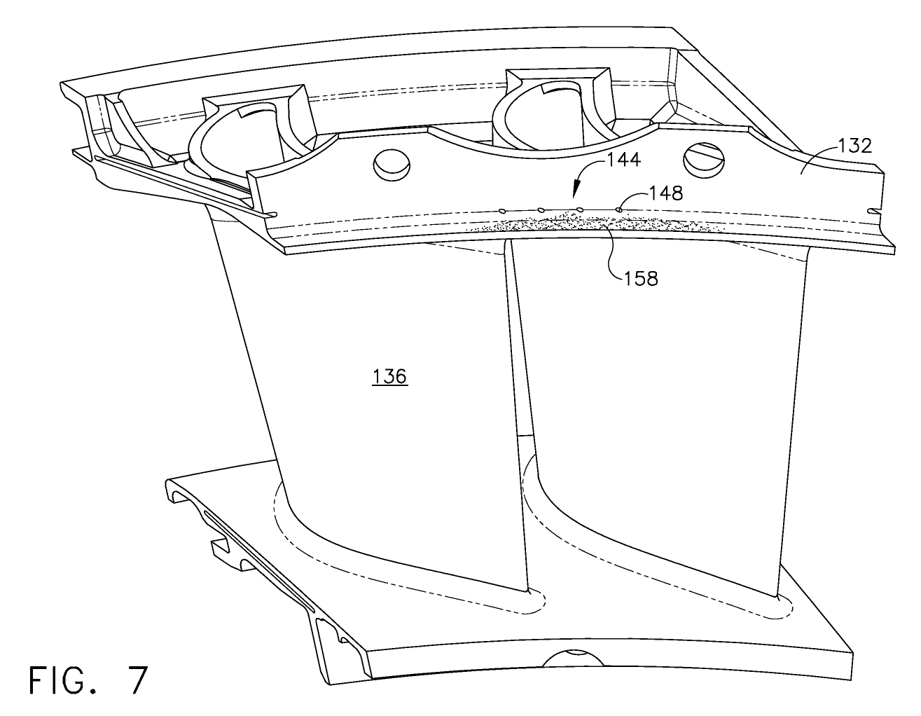

As shown in FIGS. 3-7, the high-pressure turbine 108 may include a turbine nozzle assembly 116. The turbine nozzle assembly 116 may be downstream of the combustor 106 or a row of turbine blades. The turbine nozzle assembly 116 includes an annular array of turbine nozzle segments 118. A plurality of arcuate turbine nozzle segments 118 may be joined together to form the annular turbine nozzle assembly 116. The turbine nozzle segments 118 may have an inner band 120 and an outer band 122, which radially bound the flow of combustion gases through the turbine nozzle assembly 116. The inner band 120 may have a flowpath side 124 and a non-flowpath side 126 and the outer band 122 may have a flowpath side 128 and a non-flowpath side 130. One or more flanges 132 may extend from the non-flowpath sides 126 and 130 of the inner band 120 and outer band 122. For example, as shown in FIG. 3, flange 134 extends radially from said the outer band 122 and may be used to attach the turbine nozzle assembly 116 to other components of the gas turbine engine 100.

Airfoils 136 extend radially between the inner band 120 and outer band 122 for directing the flow of combustion gases through the turbine nozzle assembly 116. The airfoils 136 have a leading edge 138 on the forward side of the turbine nozzle segment 118 and a trailing edge 140 on the aft side of the turbine nozzle segment 118. The airfoils 136 may be formed of solid or hollow construction. Hollow airfoils may include one or more internal cooling passages for cooling the airfoil and providing film cooling to the airfoil surfaces. Other hollow airfoils may include one or more cavities for receiving a cooling insert. The cooling insert may have a plurality of cooling holes for impinging on the interior surface of the hollow airfoil before exiting as film cooling through holes in the airfoil. Any configuration of airfoil known in the art may be used.

Band, as used below, may mean the inner band 120, the outer band 122 or each of the inner band 120 and outer band 122. The band may have one or more flanges 132 extending radially from the non-flowpath side 126, 130. At least one of the flanges 132 may be located near the aft side of the nozzle segment 118, such as, but not limited to, flange 134 in FIG. 3. Upstream of the flange 134, may be a plenum 142. The plenum 142 may receive cooling air from another part of the engine, such as, the high-pressure compressor 104. The cooling air may be provided to the plenum 142 through any means known in the art.

A plurality of cooling holes 144 may be disposed within the flange 134. The cooling holes 144 may have an inlet 146 at the plenum 142 on the upstream side of the flange 134 and an outlet 148 on the downstream side of the flange 134. The inlet 146 may receive cooling air from the plenum 142 and flow the cooling air through to the outlet 148. The cooling hole 144 and outlet 148 may be arranged so that the outlet 148 is directed at the aft end 150 of the band, so as to impinge on the aft end 150. The outlets 148 may have any shaped known in the art. Further, the holes 144 may be formed in any manner known in the art, such as, but not limited to, electrodischarge machining, electrochemical machining, laser drilling, mechanical drilling, or any other similar manner.

In one exemplary embodiment, as shown in FIGS. 3, 4 and 6, the cooling holes 144 may have a compound angle. The cooling holes 144 may have a first angle β measured in the radial plane (the X-Y plane) relative to a line parallel to the engine centerline 152 so that the outlet is directed at the aft end 150. The cooling holes 144 may have a second angle α measured in the circumferential plane (the X-Z plane) relative to a line parallel to the engine centerline 152 so that the cooling holes 144 are directed generally in the direction of flow exiting the nozzle segment as directed by the airfoil trailing edges 140. The first angle β may be between about 10 degrees and about 75 degrees. The second angle α may be between about 10 degrees and about 80 degrees. The cooling holes 144 may be positioned such that they are directed at an area of high pressure and temperature. In one exemplary embodiment, the cooling holes may be directed at an area 158 on the aft end 150 of the band on the non-flowpath side 126, 130 between the trailing edges 140 of the airfoils 136. In another exemplary embodiment, the cooling holes 144 may be directed at the aft end 150 in a single plane, such that the holes 144 have one angle β measured in the radial plane (the X-Y plane) relative to a line parallel to the engine centerline 152. In this exemplary embodiment, all other angles would be zero.

In one exemplary embodiment, a thermal barrier coating (TBC) 160 may be applied to the band flowpath surface 124, 128. The TBC may be between about 5 mils and about 25 mils thick. Any TBC known in the art may be used. In one exemplary embodiment, the TBC may be a three layer TBC having a MCrAlY first layer, where M is selected from the group of Ni and Co, an aluminide second layer, and a yttria-stablized zirconia (YSZ) third layer. In another exemplary embodiment, a two layer TBC may be used where platinum aluminide or aluminide may be used in place of the MCrAlY first layer and the aluminide second layer.

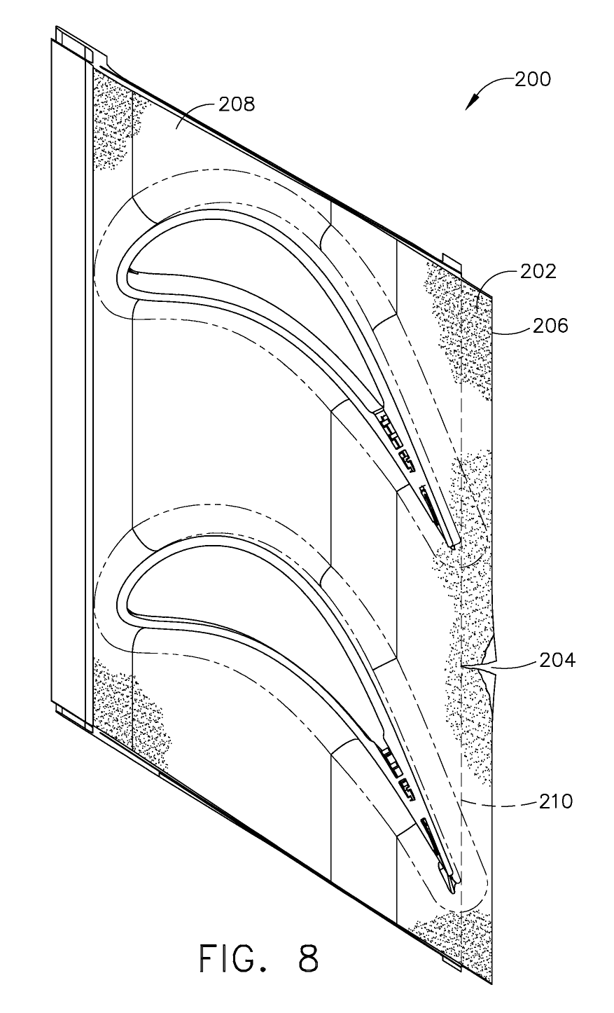

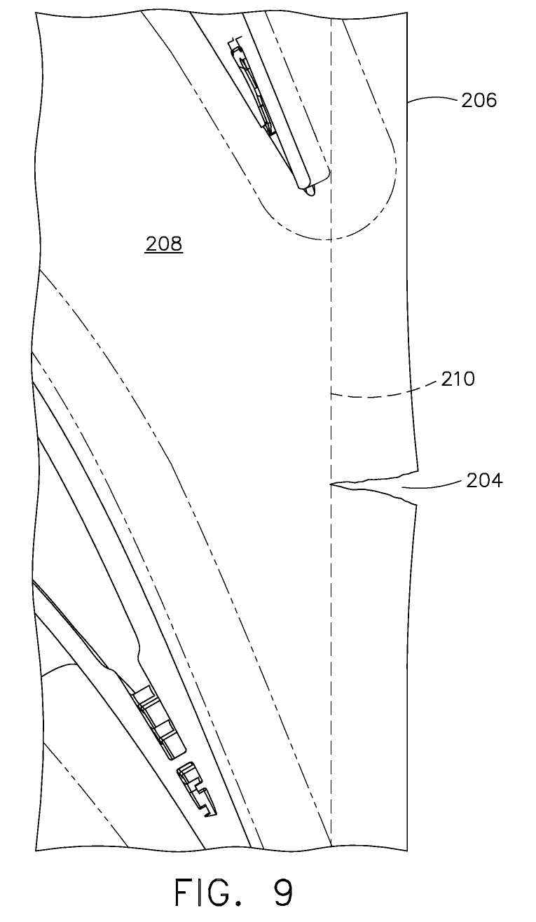

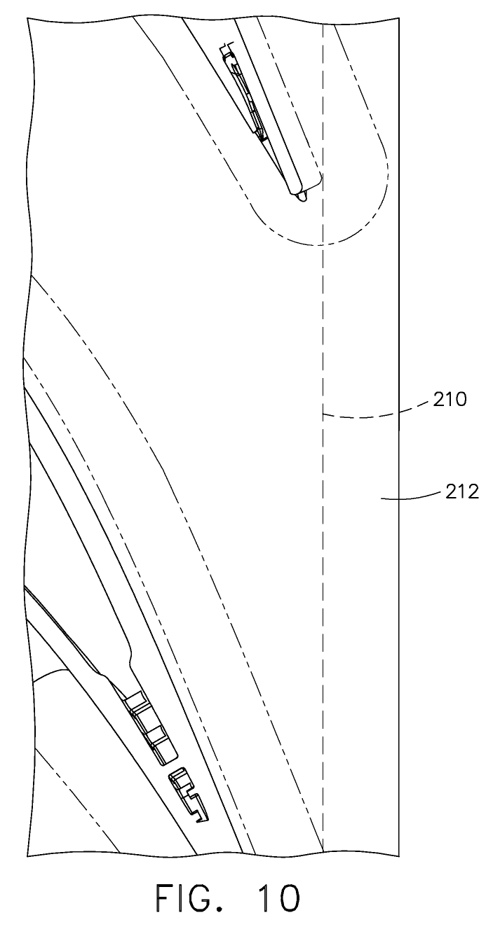

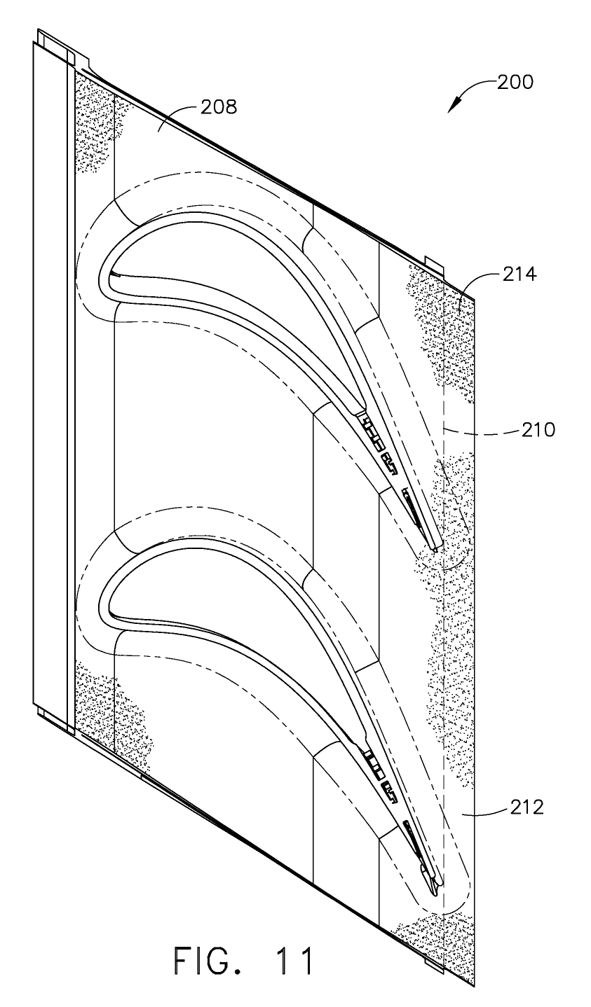

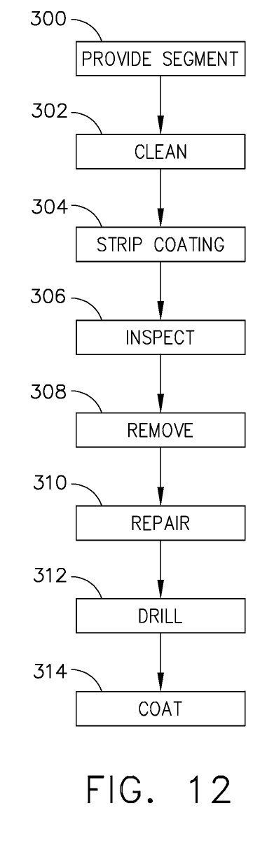

FIGS. 8-12 illustrate an exemplary embodiment of a repair procedure. An engine-run turbine nozzle segment 200 may be provided at step 300. The turbine nozzle segment 200 may or may not have holes 144. The turbine nozzle segment 200 may be coated with a thermal barrier coating 202. One or more cracks or distressed areas 204 may be disposed in one or more areas of the turbine nozzle segment 200. One particular area may be near the trailing edge 206 of the band 208, however cracks in need of repair may form in any area of the turbine nozzle segment 200.

The turbine nozzle segment 200 may be cleaned at step 302. Cleaning may include a grit blasting that may remove any corrosion from engine use. Once the turbine nozzle segment 200 is cleaned, the coating may be removed at step 304. This step may be skipped should the nozzle segment 200 not have a coating. An acid bath may be used to strip the coating. Any acid known in the art may be used. Once the coating is removed, the nozzle segment 200 may be inspected at step 306 to look for any cracks or distressed areas 204 in the base metal. If cracks 204 are found, a cut line 210 may be identified. The cut line 210 may be identified on a part-by-part basis depending on where cracks 204 are found. The cut line 210 may be a line where a cut will be made to remove a crack with the minimum amount of material removed while not imparting any additional stress into the component. The damaged material may be removed at step 308 by cutting along the cut line 210. A spad 212 that is substantially similar to the material removed may be formed. At step 310, the spad 212 may be attached to the nozzle segment 200 along the cut line 210. Any other damaged areas of the nozzle segment 204 may be repaired at the same time, either through spad replacements or through weld repairs where material is added to a damage area and then formed to normal size. At step 312, cooling holes 144 may be formed in the flange 132. The holes 144 may be formed in any manner known in the art, such as, but not limited to, electrodischarge machining, electrochemical machining, laser drilling, mechanical drilling, or any other similar manner. If the nozzle segment 200 previously included holes 144 then the holes 144 may be filled in during step 310 and re-drilled at step 312. Once all repairs are complete, a new thermal barrier coating 214 similar to that described above may be formed at step 314.

By providing cooling holes in these areas and in particular by impinging cooling air in these areas, the metal temperature may be reduced, leading to less distress and less likelihood of forming a crack or hole. As such, the turbine nozzle segment will last longer leading to less repairs and/or replacements over time for the gas turbine engine.

This written description discloses exemplary embodiments, including the best mode, to enable any person skilled in the art to make and use the exemplary embodiments. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for repairing a turbine nozzle segment having a band and a plurality of airfoils, said band having a flange, comprising:
repairing a damaged area on said turbine nozzle segment; and
drilling a plurality of cooling holes in said flange.

2. The method for repairing a turbine nozzle segment of claim 1 wherein said cooling holes are directed so as to impinge upon an aft end of a non-flowpath side of said band.

3. The method for repairing a turbine nozzle segment of claim 1 wherein said cooling holes have a compound angle relative to a line parallel to the engine centerline.

4. The method for repairing a turbine nozzle segment of claim 1 further comprising:
cleaning said turbine nozzle segment prior to said repairing step.

5. The method for repairing a turbine nozzle segment of claim 1 further comprising:
stripping a thermal barrier coating from said turbine nozzle segment prior to said repairing step.

6. The method for repairing a turbine nozzle segment of claim 1 further comprising:
inspecting said turbine nozzle segment prior to said repairing step.

7. The method for repairing a turbine nozzle segment of claim 1 wherein said repairing step further comprises:
removing a damaged portion at a cut line; and
attaching a spad to said turbine nozzle segment at said cut line.

8. The method for repairing a turbine nozzle segment of claim 1 further comprising:
coating said turbine nozzle segment with a thermal barrier coating after said drilling step.

9. The method for repairing a turbine nozzle segment of claim 1 wherein said cooling holes are angled relative to a line parallel with an engine centerline relative to the axial direction between about 10 degrees and about 75 degrees.

10. The method for repairing a turbine nozzle segment of claim 1 wherein said cooling holes are angled relative to a line parallel with an engine centerline relative to the circumferential direction between about 10 degrees and about 80 degrees.

11. A method for repairing a turbine nozzle assembly having a band and a plurality of airfoils, said band having a flange having a plurality of cooling holes, comprising:
repairing a damaged area on said turbine nozzle segment and filling in said plurality of cooling holes; and
drilling a plurality of new cooling holes in said flange.

12. The method for repairing a turbine nozzle segment of claim 11 wherein said cooling holes are directed so as to impinge upon an aft end of a non-flowpath side of said band.

13. The method for repairing a turbine nozzle segment of claim 11 wherein said cooling holes have a compound angle relative to a line parallel to the engine centerline.

14. The method for repairing a turbine nozzle segment of claim 11 further comprising:
cleaning said turbine nozzle segment prior to said repairing step.

15. The method for repairing a turbine nozzle segment of claim 11 further comprising:
stripping a thermal barrier coating from said turbine nozzle segment prior to said repairing step.

16. The method for repairing a turbine nozzle segment of claim 11 further comprising:
inspecting said turbine nozzle segment prior to said repairing step.

17. The method for repairing a turbine nozzle segment of claim 11 wherein said repairing step further comprises:
removing a damaged portion at a cut line; and
attaching a spad to said turbine nozzle segment at said cut line.

18. The method for repairing a turbine nozzle segment of claim 11 further comprising:
coating said turbine nozzle segment with a thermal barrier coating after said drilling step.

19. The method for repairing a turbine nozzle segment of claim 11 wherein said cooling holes are angled relative to a line parallel with an engine centerline relative to the axial direction between about 10 degrees and about 75 degrees.

20. The method for repairing a turbine nozzle segment of claim 11 wherein said cooling holes are angled relative to a line parallel with an engine centerline relative to the circumferential direction between about 10 degrees and about 80 degrees.
